(19) United States
(12) Patent Application Publication
(10) Pub. No.: US 2026/0346409 A1
(43) Pub. Date: Nov. 5, 2026

(54) Ratchet DRIVER

(71) Applicant: Zhejiang Feiling Tools Co., Ltd, Jiande City (CN)

(72) Inventor: Ling Tang, Qiantan (CN)

(21) Appl. No.: 19/199,360

(22) Filed: May 5, 2025

(51) Int. Cl. B25B 15/04; B25B 23/00

(52) U.S. Cl. CPC B25B 15/04; B25B 23/0035

(57) ABSTRACT

A ratchet driver has a brake base, a brake set, a rotation shaft and a control member. The inner wall of the chamber has two symmetrical stopping portions, a first engaging portion and a second engaging portion. The first engaging portion and the second engaging portion have a deviation angle asymmetrically, and the four braking spaces are defined between the two stopping portions and the first and second engaging portions for the installation of the brake set. The deviation angle design of the first engaging portion and the second engaging portion of the brake base allows a half-tooth gap between the two symmetrical braking teeth members, so that they can form a toothed driving state with the ratchet at a moment, which helps to improve the actuation accuracy of the braking teeth member, thereby achieving the purpose of fast toothed driving at a small angle.

### BACKGROUND OF THE INVENTION

### Field of Invention

The present invention relates to a ratchet tool, and more particularly to a ratchet driver capable of duo directions.

### Description of the Related Art

Currently, a screwdriver with a ratchet device is on the market, and this screwdriver utilizes the ratchet and the braking teeth member to transmit torque. When in use, the screwdriver is rotated in one direction so as to twist the part for locking or loosening. When in reverse rotation, the braking teeth member and the ratchet form an idling disengagement state, so that the driving end of the screwdriver does not need to be away from the parts and the user's hand and the handle can be returned to an angle convenient for twisting and applying force. Therefore, the purpose of quickly tightening or loosening the parts can be achieved without pausing.

However, all the tooth angles on the braking teeth member of the above-mentioned ratchet screwdriver are designed to be equiangular, and the teeth are designed to correspondingly engage with the ratchet teeth of the ratchet. When the braking teeth member and the ratchet engage again after idling, the teeth of the toothed member must pass over the ratchet teeth before they are actually engaged, which makes it easy for the teeth and the ratchet teeth to be damaged by friction. Moreover, when they are not actually engaged, they have to pass at least one tooth distance before they can match each other again, which causes obvious step skipping during the torsion of the tool and increases the collision force between the teeth, which not only affects the stability of the operation, but also greatly reduces the service life of the braking teeth member.

Therefore, it is desirable to provide a ratchet driver to mitigate and/or obviate the aforementioned problems.

### SUMMARY OF THE INVENTION

An objective of present invention is to provide a ratchet driver, which is capable of improving the above-mention problems.

### SUMMARY OF THE DISCLOSURE

In order to achieve the above-mentioned objective, a ratchet driver has a brake base, a brake set, a rotation shaft and a control member. The brake base has a chamber axially at an end, two symmetrical stopping portions, and a first engaging portion and a second engaging portion alternatively and convexly arranged on an inner circular wall of the chamber. The first engaging portion and the second engaging portion respectively and asymmetrically have a deviation angle, and four braking spaces are defined between the two stopping portions and the first and second engaging portions. A first positioning groove, a second positioning groove and a third positioning groove are equidistantly arranged on the inner circular wall of the chamber. The brake set has four braking teeth members and four elastic members, one end of each of the braking teeth members is coupled with an elastic member and respectively arranged in one of the four braking spaces, one end of the elastic member abutting against an edge of the stopping portion to push the braking teeth member toward the first and second engaging portions respectively, and each of the braking teeth members has a toothed portion. The rotation shaft has an axle and a ratchet formed on an outer edge of the axle, a plurality of ratchet teeth are disposed at an outer peripheral surface of the ratchet, the ratchet is assembled into the chamber and the ratchet teeth facing the toothed portion of the braking teeth members, and an end of the axle has a non-circular tool hole. The control member is axially and respectively penetrated with a central hole at opposing ends and jacketing onto the rotation shaft to be assembled in the chamber. A first stopper and a second stopper protrude on a surface of an end of the control member corresponding to the first and second engaging portions. A through hole is disposed on an outer edge of the control member and accommodates an elastic member and a positioning member, the elastic member pushing the positioning member outward to engage with one of the first, second and third positioning grooves.

Other objects, advantages, and novel features of invention will become more apparent from the following detailed description when taken in conjunction with the accompanying drawings.

### BRIEF DESCRIPTION OF THE DRAWINGS

FIG. 1 is a three-dimensional combination drawing of a preferred embodiment of the present invention.

FIG. 2 is an exploded view of the preferred embodiment of the present invention.

FIG. 3 is a combined sectional view of the preferred embodiment of the present invention.

FIG. 4 is a schematic drawing showing the first and second engaging portions and the first and second stoppers having deviation angles between them according to the preferred embodiment of the present invention.

FIG. 5 is a schematic drawing showing the engagement of the positioning member of the control member and the second positioning groove of the brake base according to the preferred embodiment of the present invention.

FIG. 6 is a schematic drawing showing that the brake member is engaged with the ratchet when rotating clockwise or counterclockwise according to the preferred embodiment of the present invention.

FIG. 7 is a schematic drawing showing the engagement of the positioning member of the control member and the first positioning groove of the brake according to the preferred embodiment of the present invention.

FIG. 8 is a schematic drawing showing the brake member with the ratchet when the brake member rotates clockwise according to the preferred embodiment of the present invention.

FIG. 9 is a schematic drawing showing the brake member rotating counterclockwise and forming an idling state with the ratchet according to the preferred embodiment of the present invention.

FIG. 10 is a schematic drawing showing that the brake member rotates clockwise again to change gears and engage with the ratchet according to the preferred embodiment of the present invention.

FIG. 11 is a schematic drawing showing the engagement of the positioning member of the control member and the third positioning groove of the brake base according to the preferred embodiment of the present invention.

FIG. 12 is a schematic drawing showing the brake member rotating counterclockwise and engaging with the ratchet according to the preferred embodiment of the present invention.

### DETAILED DESCRIPTION OF PREFERRED EMBODIMENT

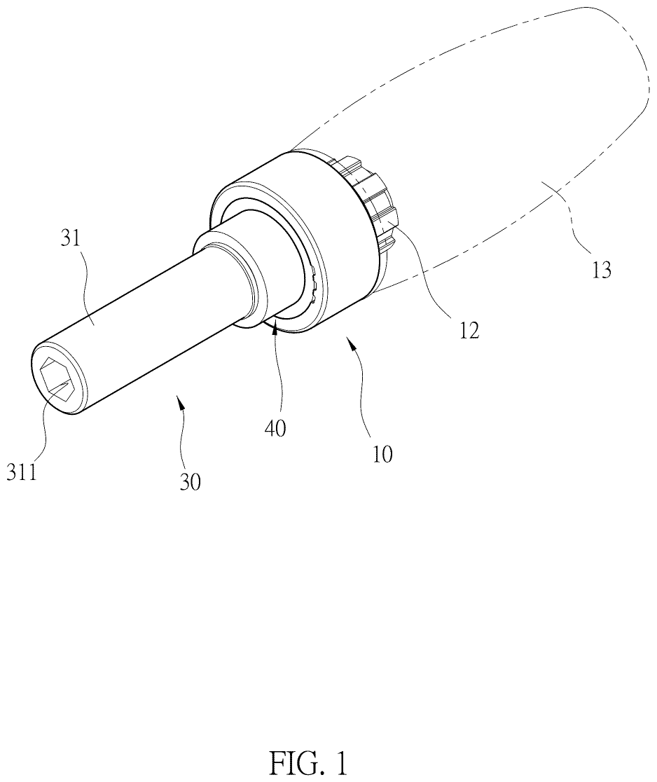

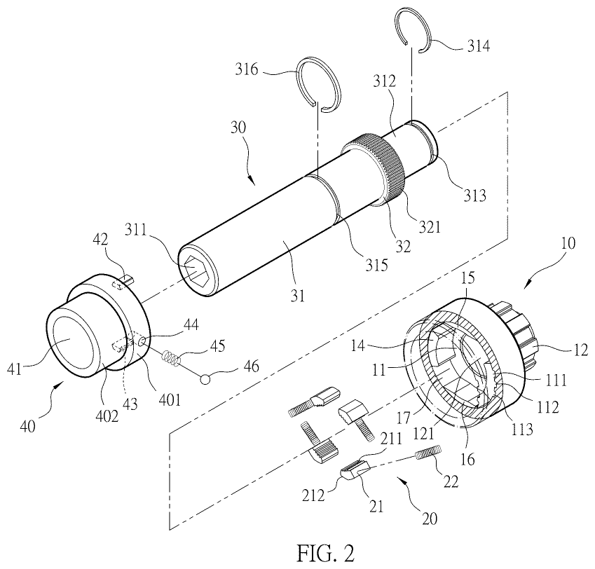

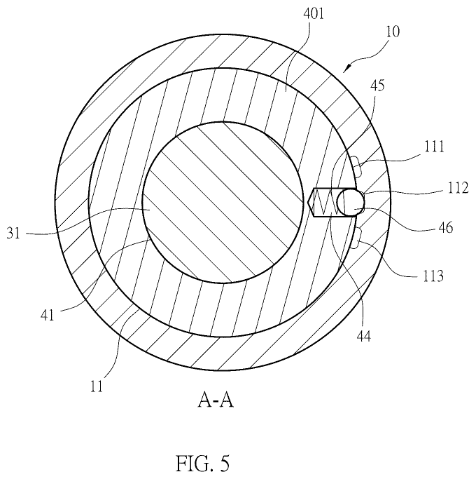

First, please refer to FIGS. 1-5. A ratchet tool comprises: a brake base 10, a brake set 20, a rotation shaft 30 and a control member 40. The brake base 10 has a chamber 11 at an end and an assembly portion 12 at another end the assembly portion for engaging with a handle 13. Two symmetrical stopping portions 14, a first engaging portion 15 and a second engaging portion 16 are alternatively and convexly arranged on an inner circular wall of the chamber 11. The first engaging portion 15 and the second engaging portion 16 asymmetrically have a deviation angle A, and four braking spaces 17 are defined between the two stopping portions 14 and the first and second engaging portions 15, 16. A first positioning groove 111, a second positioning groove 112 and a third positioning groove 113 are equidistantly arranged on the inner circular wall of the chamber 11. The brake set 20 comprises four braking teeth members 21 and four elastic members 22, and one end of each of the braking teeth members 21 is coupled with an elastic member 22 and respectively arranged in one of the four braking spaces 14. One end of the elastic member 22 abutting against an edge of the stopping portion 14 to push the braking teeth members 21 toward the first and second engaging portions 15, 16 respectively. Also, each of the braking teeth members having a toothed portion 211. Furthermore, the rotation shaft 30 comprises an axle 31 and a ratchet 32 formed on an outer edge of the axle 31. The ratchet 32 has a plurality of ratchet teeth 321 disposed at an outer peripheral surface, the ratchet 32 is assembled into the chamber 11 and the ratchet teeth 321 face the toothed portion 211 of the braking teeth members 21, and an end of the axle 31 has a non-circular tool hole 311. The control member 40 is axially and respectively penetrated with a central hole 41 at opposing ends and the central hole 41 jackets onto the rotation shaft 30 to be assembled in the chamber 11. A first stopper 42 and a second stopper 43 protrude on a surface of an end of the control member 40 corresponding to the first and second engaging portions 15, 16. A through hole 44 is disposed on an outer edge of the control member 40 and accommodates an elastic member 45 and a positioning member 46, and the elastic member 45 pushes the positioning member 46 outward to engage with one of the first, second and third positioning grooves 111, 112, 113.

Furthermore, a channel 121 is formed at the center of the inner wall of the chamber 11 axially penetrates the assembly portion 12. The rotation shaft 30 has an axle 31 and a central column 312 with a smaller diameter than the axle 31. The central column 312 is adjacent to the ratchet 32 and assembled into the channel 121, so that the ratchet 32 is pressed against the inner wall and confined in the annular space formed by the two stopping portions 14 and the first and second engaging portions 15, 16. A first ring groove 313 is provided on an outer diameter of the central column 312 and exceeds the assembly portion 12. Moreover, a C-shaped buckle 314 is engaged with the first ring groove 313 to achieve assembly positioning of the rotation shaft 30. Also, the control member 40 has large diameter section 401 and a small diameter section 402, the large diameter section 401 is assembled in the chamber 11 and abuts against the sidewalls of the stopping portion 14 and the first and second engaging portion 15, 16. The through hole 44 is arranged on an outer edge surface of the large diameter section 401 for accepting the elastic member 45 and the positioning member 46. The rotation shaft 30 further has a second ring groove 315 coupled with a C-shaped buckle 316, and the C-shaped buckle 316 is used to rotatably restrict the control member 40 onto the rotation shaft 30.

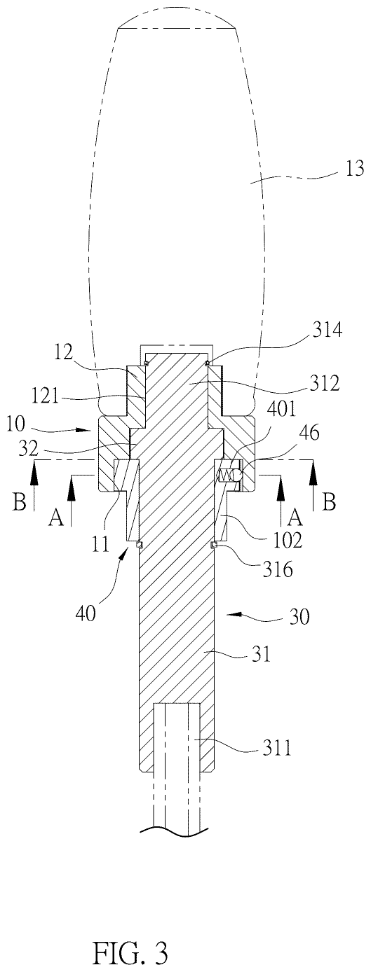

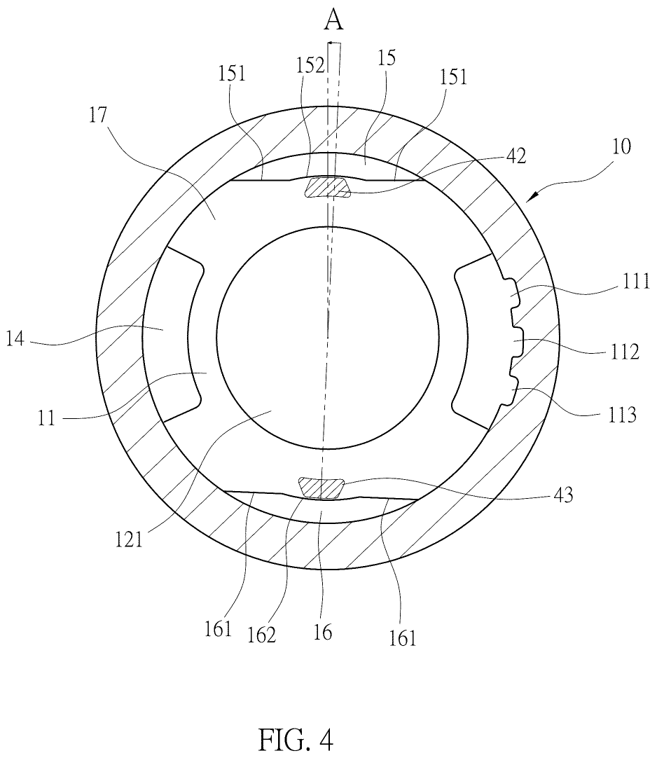

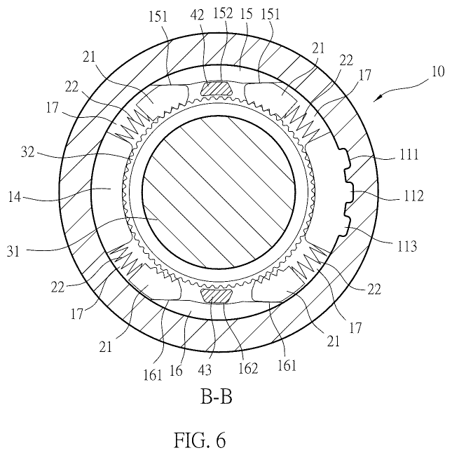

The actual use state of the structure is shown in FIGS. 1 and 3 in conjunction with FIGS. 4, 5 and 6. The first stopper 42 and the second stopper 43 of the control member 40 are designed corresponding to the first engaging portion 15 and the second engaging portion 16 respectively, so that the positions of the first and second stoppers 42 and 43 are not located on the same straight line position of the diameter of the large diameter section 401, and both have a deviation angle of at least 3⁰. Accordingly, when the positioning member 46 of the control member 40 is locked and positioned with the second positioning groove 112 of the brake base 10, the first stopper 42 is relatively located on the neutral surface 152 of the first engaging portion 15, and the second stopper 43 is relatively located on the neutral surface 162 of the second engaging portion 16, so that all of the braking teeth members 21 are not blocked by the first and second stoppers 42 and 43, and the abutting surface 151 of the first engaging portion 15 or the abutting surface 161 of the second engaging portion 16 is able to abut against the braking teeth member 21 and the ratchet teeth 321 of the ratchet 32 to form an engagement state. Therefore, the brake base 10 is able to drive the rotation shaft 30 to rotate clockwise or counterclockwise without generating idling. Furthermore, with to the design of the deviation angle A of the first and second engaging portions 15, 16, the two braking teeth member 21 located at an upper position in FIG. 6 engages with the ratchet 32, while the two braking teeth member 21 located at the lower position in FIG. 6 is disengaged with the ratchet 32 due to the half-tooth distance. When the brake base 10 rotates clockwise, the braking teeth member 21 located at the upper position of FIG. 6 and at the clockwise direction is abutted against by the abutting surface 151 of the first engaging portion 15 at the clockwise direction and engages with the ratchet 32, thereby driving the rotation shaft 30 to rotate clockwise. When the brake base 10 rotates counterclockwise, the braking teeth member 21 located at the upper position in FIG. 6 and at the counterclockwise direction abuts against by the abutting surface 151 of the first engaging portion 15 at the counterclockwise direction and engages with the ratchet 32, thereby driving the rotation shaft 30 to rotate counterclockwise. On the contrary, when the two braking teeth members 21 at the lower position form a engagement state with the ratchet 32, the two braking teeth members 21 at the upper position also form a disengagement state with the ratchet 32 due to the half-tooth distance (not shown).

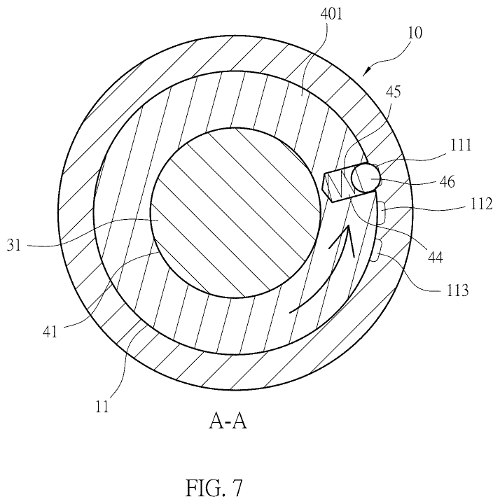

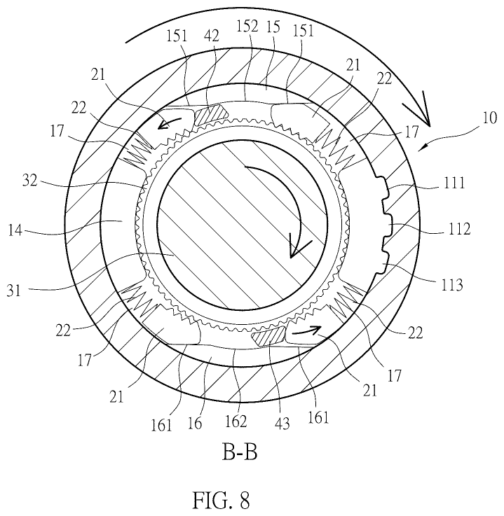

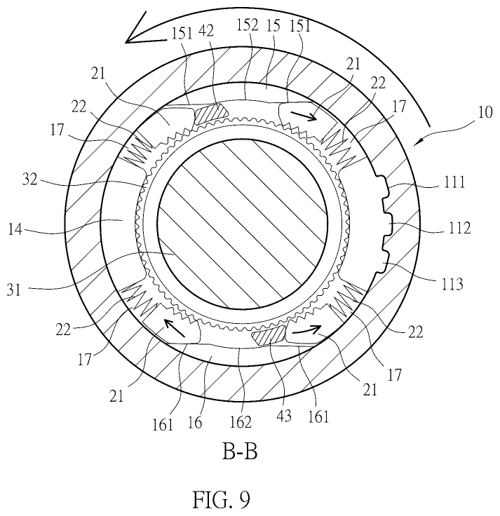

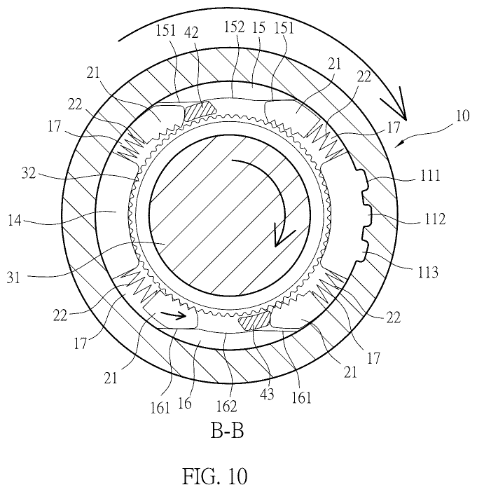

When the control member 40 rotates counterclockwise and is positioned by the positioning member 46 and the first positioning groove 111 of the brake base 10, as shown in FIGS. 1 and 3 in conjunction with FIGS. 7 and 8, the first and second stoppers 42 and 43 of the control member 40 rotate counterclockwise and move toward the abutting surfaces 151 and 161 of the first and second engaging portions 15 and 16 at the counterclockwise direction respectively, so as to push the two braking teeth members 21 located at the counterclockwise direction of the first and second engaging portions 15, 16 to retract counterclockwise (the two braking teeth members 21 located in the two braking spaces 17 on the diagonal line), and make the docking portion 212 of the two braking teeth members 21 away from the abutting surfaces 151,161 of the first and second engaging portions 15, 16 at the counterclockwise direction. With the deviation angle A of the first and second engaging portion 15, 16, the braking teeth member 21 located at the upper clockwise position in FIG. 8 engages with the ratchet 32, while the braking teeth member 21 located in the lower clockwise position disengages with the ratchet 32 due to the half-tooth distance. At this time, when the brake base 10 rotates clockwise, the braking teeth member 21 at the upper clockwise direction in FIG. 8 is abutted against by the abutting surface 151 of the first engaging portion 15 at the clockwise direction and engages with the ratchet 32, thereby driving the rotation shaft 30 to rotate clockwise. On the contrary, when the brake base 10 rotates counterclockwise, as shown in FIG. 9, the two braking teeth members 21 at the counterclockwise direction are away from the abutting surfaces 151, 161 of the first and second engaging portions 15, 16 at the counterclockwise directions, so that the two braking teeth members 21 cannot engage with the ratchet teeth 321 of the ratchet 32, thereby forming a counterclockwise idling state. When the brake base 10 is rotated clockwise again, due to the half-tooth gap design of the two braking teeth members 21 at the clockwise direction, the gap between the two braking teeth members 21 has a half-tooth gap, so that the braking teeth member 21 is able to engages with the ratchet teeth 321 of the ratchet 32, as shown in FIG. 10. According, the braking teeth member 21 at the clockwise direction in the lower position is abutted against by the abutting surface 161 of the second engaging portion 16 at the clockwise direction and engages with the ratchet 32, and the braking teeth member 21 located in the upper clockwise position is disengaged from the ratchet 32 due to the half-tooth distance.

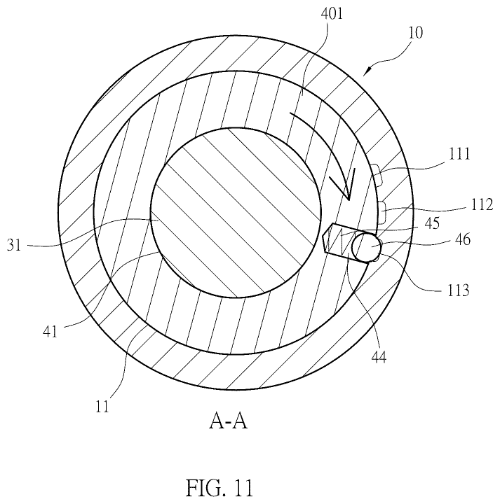

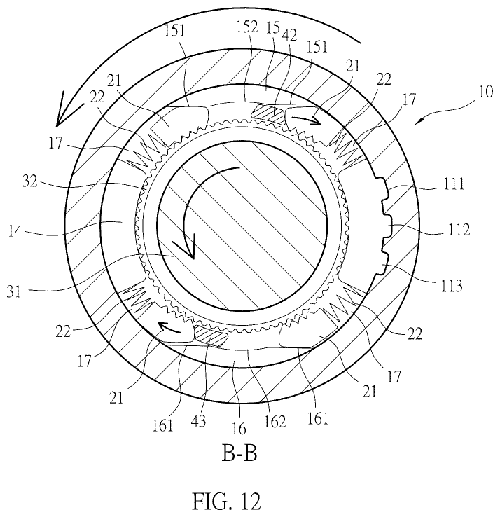

Furthermore, when the control member 40 rotates clockwise, and the positioning member 46 is engaged with the third positioning groove 113 of the brake base 10 and, as shown in FIGS. 11 and 12, the first and second stoppers 42, 43 of the control member 40 rotate clockwise and move respectively toward the abutting surfaces 151, 161 of the first and second engaging portions 15, 16 at the clockwise direction, so as to push the two braking teeth members 21 located at the clockwise direction of the first and second engaging portions 15, 16 to retract clockwise (the two braking teeth members 21 located at a diagonal line in the two braking spaces 17), and make the docking portion 212 of the two braking teeth members 21 being away from the abutting surfaces 151, 161 of the first and second engaging portions 15,16 at the clockwise direction. With the deviation angle A of the first and second engaging portion 15, 16, the braking teeth member 21 located at the upper counterclockwise position in FIG. 11 engages with the ratchet 32, while the braking teeth member 21 located at the lower counterclockwise position disengages with the ratchet 32 due to the half-tooth distance. At this time, when the brake base 10 rotates counterclockwise, the braking teeth member 21 at the upper counterclockwise direction in FIG. 11 is abutted against by the abutting surface 151 at the counterclockwise direction of the first engaging portion 15 and engages with the ratchet 32, thereby driving the rotation shaft 30 to rotate counterclockwise. On the contrary, when the brake base 10 rotates clockwise, the two braking teeth members 21 at the clockwise direction are away from the abutting surfaces 151, 161 at the clockwise directions of the first and second engaging portions 15, 16, so that the two braking teeth members 21 cannot engage with the ratchet teeth 321 of the ratchet 32, thereby forming a clockwise idling state. When the brake base 10 is rotated counterclockwise again, due to the half-tooth gap design between the two braking teeth members 21 in the counterclockwise direction, the gap between the two braking teeth members 21 is only a half-tooth gap, so that the braking teeth member can engage with the ratchet teeth 321 of the ratchet 32 at an instant.

The structure of the above-mentioned specific embodiment can obtain the following benefits: with the deviation angle A design of the first engaging portion 15 and the second engaging portion 16 of the brake base 10, the two symmetrical braking teeth members 21 have a half-tooth gap, so that one of the braking teeth member 21 can engage with the ratchet 32 for a driving state instantly, which helps to improve the actuation accuracy of the braking teeth member 21, thereby achieving the purpose of small-angle rapid engaging drive, and greatly reducing the wear and collision of the teeth, which helps to improve the service life of the ratchet tool.

Secondly, the braking space 17 is sequentially formed on the inner wall of the brake base 10, and the braking teeth member 21 and the elastic member 22 are arranged in the braking space 17. The ratchet 32 of the rotation shaft 30 is centrally assembled in the chamber 11, and the ratchet teeth 321 of the ratchet 32 face the toothed portion 211 of the braking teeth member 21, so that the rotation shaft 30 and the brake base 10 form a coaxial aligned state, which helps to reduce the component volume of the tool and achieve the effects of convenient storage, carrying and lightweight use.

Although the present invention has been explained in relation to its preferred embodiment, it is to be understood that many other possible modifications and variations can be made without departing from the spirit and scope of invention as hereinafter claimed.

What is claimed is:

1. A ratchet driver comprising:
a brake base having a chamber axially at an end, two symmetrical stopping portions, and a first engaging portion and a second engaging portion alternatively and convexly arranged on an inner circular wall of the chamber; the first engaging portion and the second engaging portion respectively and asymmetrically have a deviation angle, and four braking spaces are defined between the two stopping portions and the first and second engaging portions; a first positioning groove, a second positioning groove and a third positioning groove are equidistantly arranged on the inner circular wall of the chamber;
a brake set comprising four braking teeth members and four elastic members, one end of each of the braking teeth members coupled with an elastic member and respectively arranged in one of the four braking spaces, one end of the elastic member abutting against an edge of the stopping portion to push the braking teeth member toward the first and second engaging portions respectively, each of the braking teeth members having a toothed portion;
a rotation shaft comprising an axle and a ratchet formed on an outer edge of the axle, a plurality of ratchet teeth disposed at an outer peripheral surface of the ratchet, the ratchet assembled into the chamber and the ratchet teeth facing the toothed portion of the braking teeth members, and an end of the axle having a non-circular tool hole; and
a control member axially and respectively penetrated with a central hole at opposing ends and jacketing onto the rotation shaft to be assembled in the chamber; a first stopper and a second stopper protruding on a surface of an end of the control member corresponding to the first and second engaging portions; a through hole disposed on an outer edge of the control member and accommodating an elastic member and a positioning member, the elastic member pushing the positioning member outward to engage with one of the first, second and third positioning grooves.

2. The ratchet driver as claimed in claim 1, wherein another end of the brake base has an assembly portion for engaging with a handle.

3. The ratchet driver as claimed in claim 2, wherein a channel formed at the center of the inner wall of the chamber axially penetrates the assembly portion; the rotation shaft has an axle and a central column with a smaller diameter than the axle; the central column is adjacent to the ratchet and assembled into the channel; a first ring groove is provided on an outer diameter of the central column and exceeds the assembly portion; and a C-shaped buckle is engaged with the first ring groove to achieve assembly positioning of the rotation shaft.

4. The ratchet driver as claimed in claim 1, wherein both of the first engaging portion and the second engaging portion of the brake base respectively have two abutting surfaces at opposing ends, and a neutral surface is formed between the two abutting surfaces, the neutral surface being non-planar and having a concave arc shape; a docking portion is provided at an end of each braking teeth member and used for abutting against the abutting surface.

5. The ratchet driver as claimed in claim 4, wherein the position of the neutral surface of the first engaging portion and the position of the neutral surface position of the second engaging portion have a deviation angle of at least 3°, so that the braking teeth members abutting against the first engaging portion and the second engaging portion have a distance difference of half a tooth from each other, and the toothed portions of the braking teeth members do not simultaneously engage and release the ratchet teeth of the ratchet.

6. The ratchet driver as claimed in claim 1, wherein the control member further comprises a large diameter section and a small diameter section, the large diameter section assembled into the chamber and abutting against the stopping portion and the side walls of the first and second engaging portions, and the through hole is arranged on an outer edge surface of the large diameter section for accepting the elastic member and the positioning member.

7. The ratchet driver as claimed in claim 1, wherein the rotation shaft further has a second ring groove coupled with a C-shaped buckle, and the C-shaped buckle is used to rotatably restrict the control member onto the rotation shaft.
